(19) United States
(12) Patent Application Publication
(10) Pub. No.: US 2005/0190278 A1
(43) Pub. Date: Sep. 1, 2005

(54) Viewfinder and image photographing apparatus having the same

(75) Inventor: Seo-young Oh, Sangju-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/037,242

(22) Filed: Jan. 19, 2005

(30) Foreign Application Priority Data
Feb. 28, 2004 (KR) 2004-13799

(51) Int. Cl. H04N 5/222

(52) U.S. Cl. 348/333.01

(57) ABSTRACT

A viewfinder has a liquid crystal display device, a lens, an outer case, and an inner case. The outer case guides movement of the inner case having the lens. The outer case has a guide wall and first and second fixing grooves abutting both ends of the guide wall. The inner case has a fixing protrusion. Moving the inner case moves the fixing protrusion in close contact to the inside of the guide wall and inserts the fixing protrusion in the first or second fixing groove such that the inner case is fixed at the inserted position or the protruded position.

### CROSS-REFERENCE TO RELATED APPLICATIONS

This application claims the benefit under 35 U.S.C. § 119(a) of Korean Patent Application No. 2004-13799 filed on Feb. 28, 2004 in the Korean Intellectual Property Office, the entire disclosure of which is hereby incorporated by reference in its entirety.

### BACKGROUND OF THE INVENTION

1. Field of the Invention

The present invention relates to an image photographing apparatus. More particularly, the present invention relates to a viewfinder capable of adjusting the length thereof, and an image photographing apparatus having the same.

2. Description of the Related Art

As is well-known, an image photographing apparatus such, as a camcorder, records an image of a subject on a recording media, such as a magnetic tape, and reproduces the recorded image. The image photographing apparatus includes an electronic viewfinder (EVF) for a user to check a recording image of a subject.

Generally, a viewfinder includes a liquid crystal display for displaying an image to be recorded or reproduced, and a lens for a user to observe an image displayed through the liquid crystal display. A viewfinder is configured to protrude by a certain length from a main body of an image photographing apparatus for convenience of use. However, as liquid crystal monitors are now being used in the image photographing apparatus, the frequency of using a viewfinder is reduced, and therefore, the structure of a viewfinder protruding outside of an image photographing apparatus main body is a problem to be avoided.

In view of the above, the Korean Utility Model No. 2000-0016781 by the present applicant discloses a viewfinder having an adjustable length. The viewfinder includes an inner case having a liquid crystal display device; and an outer case having a lens device. The inner case is fixed on an image photographing apparatus main body, and the outer case is slidably mounted with respect to the inner case. Accordingly, when the viewfinder is not in use, the outer case is pushed into a main body to locate the viewfinder in an inserted position, and when the viewfinder is in use, the outer case is drawn from the main body to locate the viewfinder in a protruded position. The inner case includes two springs to fix the outer case at the inserted position or the protruded position. The two springs are plate springs, and securely attached to the inner case by screws.

The disclosed viewfinder requires separate springs for fixing the outer case on the inserted position or the protruded position, and the springs have to be attached to the inner case. Therefore, the structure is complicated and assembling, processing and manufacturing costs increase. Furthermore, the outer case may be damaged by friction with the springs.

Therefore, a need exists for a length adjustable viewfinder that is less complicated and does not damage the viewfinder or housing therefor.

### SUMMARY OF THE INVENTION

An embodiment of the present invention has been conceived to solve the above-mentioned problems occurring in the prior art, and an aspect of the present invention is to provide a viewfinder having a liquid crystal display (LCD), a lens, an outer case and an inner case. The outer case guides movement of the inner case having the lens. A viewfinder, which has a simple structure and is capable of adjusting its length, is therefore provided.

A viewfinder has a guide wall at the outer case. First and second fixing grooves abut both ends of the guide wall. A fixing protrusion is formed on an outside of the inner case. When the inner case is moved, the fixing protrusion is moved in close contact to the inside of the guide wall and when the fixing protrusion is inserted in the first or the second fixing groove, the inner case movement is retrained.

The viewfinder further includes a guide groove in the outer case. A hook in the inner case is received by the guide groove, and ends of the guide groove prevent further movement of the hook within the guide groove. The hook prevents the inner case from separating from the outer case.

The guide wall may be integrally formed with the outer case by molding, and the fixing protrusion and the hook may be integrally formed with the inner case by molding.

The liquid crystal display device may be mounted to the inner case.

An image photographing apparatus according an embodiment of the present invention includes a viewfinder having a liquid crystal display (LCD) device and a lens. The viewfinder includes an outer case attached to an image photographing apparatus main body, and an inner case movably mounted with the outer case. The outer case guides movement of the inner case having the lens.

The outer case is securely attached to the image photographing apparatus main body by screws.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above and other aspects, features and advantages of the present invention will be more apparent from the following detailed description taken with reference to the accompanying drawings, in which:

FIG. 1 is a perspective view of an image photographing apparatus according to an embodiment of the present invention;

FIG. 2 is a perspective view of an image photographing apparatus having a viewfinder according to an embodiment of the present invention;

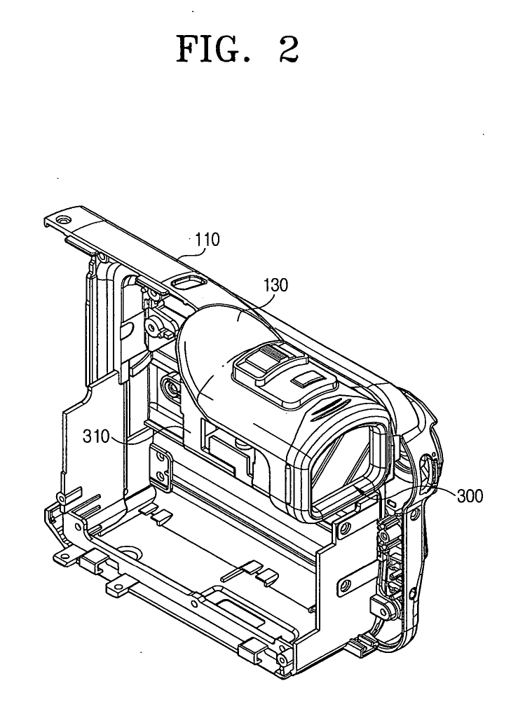

FIG. 3 is an exploded perspective view of a viewfinder according to an embodiment of the present invention;

FIG. 4 is a perspective view of the viewfinder of FIG. 3 in an assembled condition; and

FIGS. 5A and 5B are side elevational views of the operation of the viewfinder of FIG. 3.

Throughout the drawings, like reference numerals will be understood to refer to like parts, components and structures.

### DETAILED DESCRIPTION OF EXEMPLARY EMBODIMENTS

Certain embodiments of the present invention will be described in greater detail with reference to the accompanying drawings.

The matters defined in the description, such as a detailed construction and elements thereof, are provided to assist in a comprehensive understanding of the invention. Thus, it is apparent that the present invention may be carried out without those defined matters. Also, well-known functions or constructions are not described in detail since they may obscure the invention in unnecessary detail.

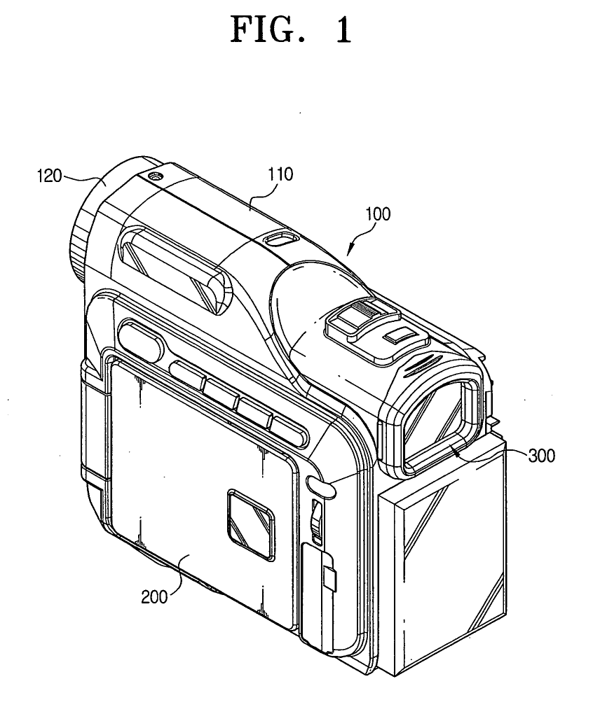

As shown in FIG. 1, an image photographing apparatus according to an embodiment of the present invention mainly comprises a main body 100, a liquid crystal display LCD monitor 200 and a viewfinder 300.

The image photographing apparatus main body 100 includes a housing 110 forming the external appearance, a camera unit (not shown), a deck unit (not shown), and a control unit (not shown). The camera unit, deck unit and control unit are mounted in the housing 110. The camera unit photographs an image and converts the image to an image signal. The camera unit includes a camera lens 120 mounted to be exposed at one side of the housing 110. The deck unit includes a recording media mount part for mounting a recording media, such as a magnetic tape and a flash memory. A signal reproducing and recording device, such as a head drum, that records an image signal or reproduces the recorded image signal on and from a recording media. The control device controls the entire operation of an image photographing apparatus.

The liquid crystal display LCD monitor 200 displays a photographed or reproduced image, and is mounted to one side of an image photographing apparatus main body 100.

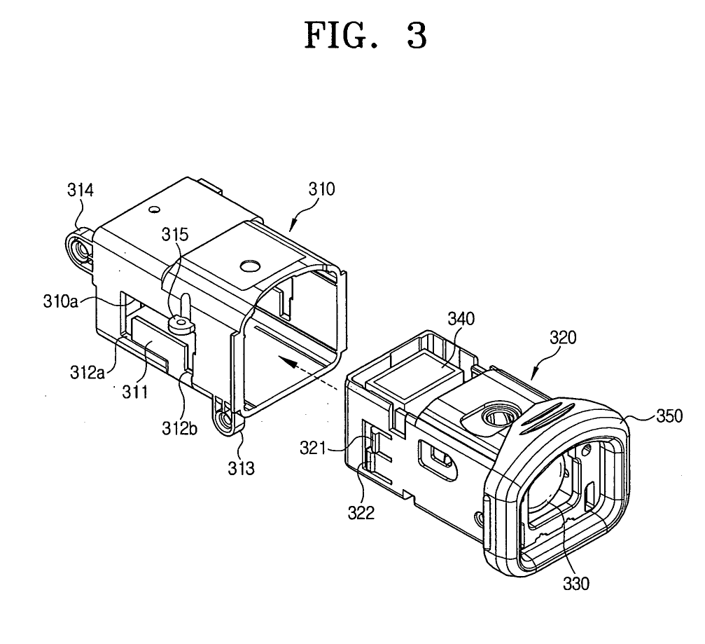

Like the liquid crystal display LCD monitor 200, the viewfinder 300 also displays a photographed or reproduced image, and is length-adjustably mounted to the image photographing apparatus main body 100. The viewfinder 300 includes an outer case 310, an inner case 320, a lens 330 and a liquid crystal display device 340, as shown in FIG. 3.

The outer case 310 guides the movement of the inner case 320, and is fixed in the image photographing apparatus main body 100. Both sides of the outer case 310 have a guide wall 311, a guide groove 310a, and first and second fixing grooves 312a and 312b. The first and second fixing grooves 312a and 312b abutboth ends of the guide wall 311 such that the guide wall 311 is located between the first fixing groove 312a and the second fixing groove 312b, as shown in FIG. 3. The guide groove 310a extends in the direction of length of a side of the outer case 310, and is preferably approximately the same size as the length between the first fixing groove 312a and the second fixing groove 312b, as shown in FIG. 3. An outer surface of the outer case 310 has a plurality of boss parts 313, 314, 315 adapted to receive fasteners. to secure the outer case 310 to the housing 110. The upper side of the outer case 310 fixed in the housing 110 is covered by the viewfinder so to not be visible. Preferably, the outer case 310 is integrally formed with the guide wall 311 and boss parts 313, 314 and 315 by molding, such that processing and manufacturing costs may be reduced.

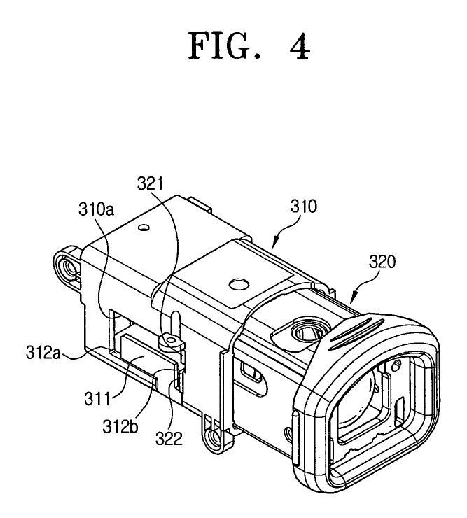

The inner case 320 is movably mounted within the inside of the outer case 310. A hook 321 and a fixing protrusion 322 are mounted on each side of the inner case 320. The hook 321 is inserted in the guide groove 310a of the outer case 310 when the inner case 320 is fitted in the outer case 310, as shown in FIG. 4. The hook 321 is moved along the guide groove 310a when the inner case 320 is moved. The fixing protrusion 322 is inserted in the first fixing groove 312a or the second fixing groove 312b of the outer case 310 when the inner case 320 is fitted in the outer case 310. The fixing protrusion 322 has a rounded surface to easily separate from the first fixing groove 312a or the second fixing groove 312b. When the inner case 320 is moved by guide of the outer case 310, the fixing protrusion 322 is moved from the first fixing groove 312a to the second fixing groove 312b, or from the second fixing groove 312b to the first fixing groove 312a, in close contact to the inside of the guide wall 311. In the inner case 320, the hook 321 and the fixing protrusion 322 are preferably integrally formed by molding. The inner case 320 is made of the same material as the outer case 310.

The inner case 320 has a liquid crystal display device 340 for displaying a photographed or reproduced image. A lens 330 enlarges the image displayed on the liquid crystal display device 340 for observation by a user. The liquid crystal display device 340 is electronically connected with the image photographing apparatus main body 100 through a connecting member, such as a flexible printed circuit (FPC). The lens 330 is attached in a conventional manner to the inside of the inner case 320 to be movable therewith. An eyecup 350 is fit over the outer end of the inner case 320.

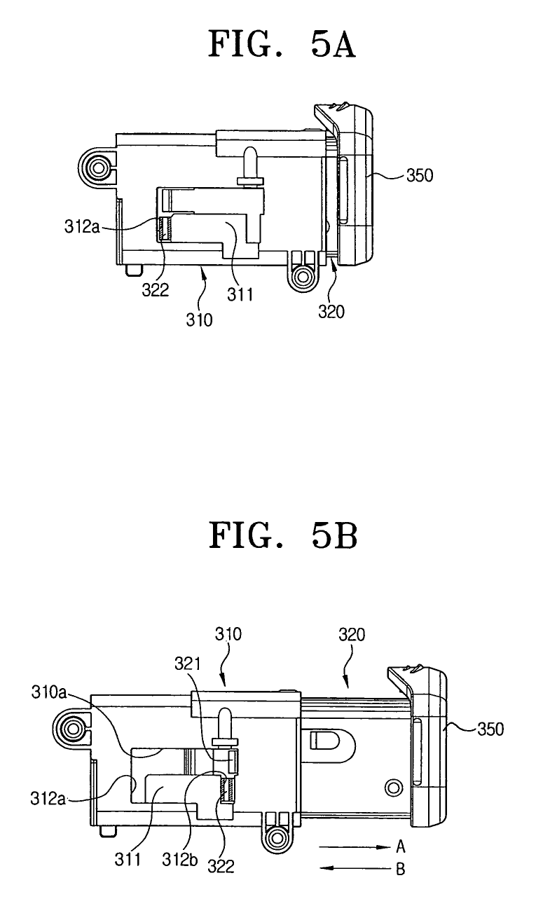

FIG. 5A shows a condition in which the viewfinder is not in use so that the inner case 320 is substantially completely inserted in the outer case 310. Referring to FIG. 5A, the fixing protrusion 322 of the inner case 320 is inserted in the first fixing groove 312A of the outer case 310. At this time, the fixing protrusion 322 is contacted with one end of the guide wall 311 such that the inner case 320 may not be easily moved in the lengthwise direction indicated by arrow A (refer to FIG. 5B).

To use the viewfinder 300, the eyecup 350 and the inner case 320 are drawn out from the outer case 310. As shown in FIG. 5B, as the inner case 320 is subjected to the pressure in the lengthwise direction indicated by arrow A to move the viewfinder to a protruded position, the fixing protrusion 322 inserted in the first fixing groove 312a is separated from one side of the guide wall 311 and is moved in contact with the inside of the guide wall 311 to be inserted in the second fixing groove 312b. When the hook 321 in the guide groove 310a is contacted with the outside of the outer case 310 at the end of the guide groove 310a, the inner case 320 is prevented from further lengthwise movement in the direction indicated by arrow A. With the viewfinder in the protruded position, the fixing protrusion 322 is inserted in the second fixing groove 312b so that the inner case 320 is stopped from further lengthwise movement. The fixing protrusion 322 is contacted with the other end of the guide wall 311 such that the inner case 320 may not be moved to the insertion direction B. Accordingly, the inner case 320 is held in drawn-out position for a proper use of a viewfinder 300.

If a user pushes the eyecup 350 in the insertion direction indicated by arrow B, the fixing protrusion 322 is separated from the second fixing groove 312b, and is moved in contact with the inside of the guide wall 311 to be again inserted in the first fixing groove 312a.

As a construction part for guiding movement of the inner case 320, a guide groove 310a, the first and second fixing grooves 312a, 312b and the guide wall 311 are preferably formed integrally with the outer case 310. The hook 321 and the fixing protrusion 322 are preferably formed integrally with the inner case 320, and therefore, the structure of the viewfinder is simple. Accordingly, an image photographing apparatus that is simple to assemble and process and has low manufacturing costs is provided.

Finally, since the outer case 310 and the inner case 320 are made of the same material, abrasion by friction between the outer case 310 and the inner case 320 is substantially eliminated.

Additional advantages, objects, and features of the embodiments of the invention will be set forth in part in the description that follows and in part will become apparent to those having ordinary skill in the art upon examination of the description, or may be learned from practice of the invention. The objects and advantages of the embodiments of the invention may be realized and attained as particularly pointed out in the appended claims.

1. A viewfinder connected to a main body of an image photographing apparatus, comprising:
a liquid crystal display device;
a lens;
an outer case attached to the main body; and
an inner case having the lens mounted therein, the inner case being movably mounted in the outer case,
wherein the outer case guides the movement of the inner case.

2. The viewfinder according to claim 1, wherein
first and second fixing grooves are formed in the outer case at a predetermined distance apart from each other; and
a fixing protrusion is connected to the inner case, the fixing groove substantially preventing movement of the inner case when the fixing groove is inserted in one of the first or second fixing grooves.

3. The viewfinder according to claim 2, wherein
the outer case has a guide wall the fixing protrusion being moved in contact with the inside of the guide wall when the inner case is moved.

4. The viewfinder according to claim 3, wherein
the outer case is integrally formed with the guide wall by molding.

5. The viewfinder according to claim 2, wherein
the inner case is integrally formed with the fixing protrusion by molding.

6. The viewfinder according to claim 1, wherein
the outer case has a guide groove having first and second ends; and
the inner case has a hook adapted to be received by the guide groove, the hook engaging the first and second ends of the guide groove during movement to prevent the inner case from separating from the outer case.

7. The viewfinder according to claim 6, wherein
the inner case is integrally formed with the hook by molding.

8. The viewfinder according to claim 1, wherein
the liquid crystal display device is secured to the inner case.

9. The viewfinder according to claim 1, wherein
a plurality of bosses extend from an outer surface of the outer case and are adapted to receive fasteners to secure the outer case to the main body.

10. The viewfinder according to claim 9, wherein
the plurality of the bosses are integrally formed with the outer case by molding.

11. The viewfinder according to claim 1, wherein
the inner and outer cases are made of substantially the same material to reduce friction therebetween.

12. An image photographing apparatus, comprising:
a viewfinder for photographing an image of a subject and recording the image on a recording media, the viewfinder including
a liquid crystal display device;
a lens;
an outer case attached to a main body of the image photographing apparatus; and
an inner case to which the lens is connected, the inner case being movably mounted in the outer case,
wherein the outer case guides movement of the inner case.

13. The image photographing apparatus according to claim 12, wherein
the outer case is securely attached to the image photographing apparatus main body by fasteners.

14. The image photographing apparatus according to claim 13, wherein
the fasteners are screws.

15. The image photographing apparatus according to claim 9, wherein
the outer case has a guide groove having first and second ends; and
the inner case has a hook adapted to be received by the guide groove, the hook engaging the first and second ends of the guide groove during movement to prevent the inner case from separating from the outer case.

16. The image photographing apparatus according to claim 15, wherein
when the hook is in the first end of the guide groove the viewfinder is in the inserted position, and when the hook is in the second end of the guide groove the viewfinder is in the protruded position.
